(19) United States
(12) Patent Application Publication
(10) Pub. No.: US 2011/0227365 A1
(43) Pub. Date: Sep. 22, 2011

(54) RETRACTABLE VEHICLE ROOF APPARATUS AND VEHICLE HAVING THE SAME

(76) Inventors: Dehe Mao, Shenzhen (CN); Hu Man, Shenzhen (CN); Hongfei Yan, Shenzhen (CN); Yi Qin, Shenzhen (CN); Tao Liu, Shenzhen (CN)

(21) Appl. No.: 13/069,303

(22) Filed: Mar. 22, 2011

Related U.S. Application Data
(63) Continuation of application No. PCT/CN2009/074197, filed on Sep. 24, 2009.

(30) Foreign Application Priority Data
Sep. 24, 2008 (CN) 200820137229.X

(51) Int. Cl. B60J 7/14

(52) U.S. Cl. 296/108

(57) ABSTRACT

A retractable vehicle roof apparatus comprises a roof, a rear windshield hinged to the roof, a trunk cover, a rear shelf disposed at the rear windshield and moveable between a horizontal position in which the rear shelf provides a sealing structure for the vehicle and a vertical position in which the rear shelf provides a space for the passage of the roof and the rear windshield, and closure flaps mounted on the trunk cover and moveable between an extended position in which the closure flaps are located at both sides of the trunk cover respectively and a retracted position in which the closure flaps are attached to a lower surface of the trunk cover. A vehicle comprises the above-mentioned retractable vehicle roof apparatus.

### CROSS-REFERENCE TO RELATED APPLICATION

This application claims priority to and benefit of Chinese Patent Application Serial No. 200820137229.X, filed in the State Intellectual Property Office of the P. R. China on Sep. 24, 2008. This application is a continuation of International Patent Application No. PCT/CN2009/074197 designating the United States, the entire content of which is incorporated herein by reference.

### BACKGROUND OF THE INVENTION

1. Field of the Invention

The present invention relates to a retractable vehicle roof apparatus and vehicles having the retractable vehicle roof apparatus.

2. Background of the Related Art

With the social and economic developments, people pay more attention to the quality of life. Convertible sport cars become more and more popular. The roof of the convertible sport car should ensure a sealed condition in the extended position in order to have all-weather suitability. Also, the roof should be safe and stable during opening and closing.

Compared to vehicles fitted with triple-collapsed roofs, vehicles fitted with double-collapsed roofs are simpler in configuration, but need longer trunks to receive the roofs. It is more difficult to drive a vehicle having a longer trunk. Thus a roof retracting apparatus is needed to retract a long roof into a trunk and ensure the sealed condition.

A retractable hard roof is disclosed in the Chinese patent publication CN1293122A. The retractable hard roof comprises an upper roof part and a rear roof part, which are connected to each other via a link assembly. When the roof is at the retracted position, the upper roof part moves into the interior of the rear roof part and retracts into a receiving space together with the rear roof part. CN1293122A does not consider the sealed condition when the roof is in the closed and retracted position.

A retractable hard roof of a vehicle is disclosed in Chinese Utility Model CN2880565Y. The hard roof comprises a base, a first link connected to the front end of the base, a second link connected to the rear end of the base, and a third link connected between the first link and the second link. The second link comprises a rear link and a front link connected to the rear link. During operation, by driving the respective links to act through a hydraulic system, the roof is moved between an extended position in which the roof is extended and covers the top of the vehicle and a refracted position in which the roof retracts into the roof receiving space. CN2880565Y does not disclose a mechanism providing the sealing condition. The hard roof will have a negative effect on the esthetic and aerodynamic performance of the vehicle when the roof is extended and retracted.

A retractable roof apparatus and a vehicle fitted with the same are disclosed in Chinese patent publication CN1750952A. The retractable roof apparatus comprises a rear cover. The rear cover comprises a rear shelf and two closure flaps on both sides of the rear shelf. The rear cover can be moved so as to permit the passing through of the roof and the guiding means thereof when the roof moves between the extended position and the refracted position. The rear cover provides a sealing structure when the roof is in the extended position or refracted position. The movement of the rear cover is in a linkage relationship with that of the roof. Concretely, during the movement of the roof, the extension of the guiding means of the roof causes rotation of the cam. Then the cam actuates the rear cover to move via an L-shaped lever. With continuous rotation of the guiding means of the roof, the extension of the guiding means comes into trigger with the pully and causes rotation of the pully. The rotation of the pully generates a tractive force on a cable fixed to the pully. At the other end of the cable, this tractive force acts on an actuating mechanism of the closure flaps and further causes opening or closing of the closure flaps. Vehicles fitted with the retractable roof apparatus suffer from many disadvantages. Firstly, that the start points of the parts are not concurrent and the cable derails results in ruinous consequences such as rupture of the rear shelf and stop of the roof. Secondly, the retractable roof apparatus which is complicated in configuration needs to be manufactured and assembled in high accuracy. Thirdly, it is difficult to adjust the relationship between the trunk cover and the roof. Fourthly, the operation of the retractable roof apparatus is not stable.

### SUMMARY OF THE INVENTION

An object of the present invention is to provide an improved retractable vehicle roof apparatus which is simpler in structure and more reliable and stable in operation.

According to an embodiment of the present invention, the retractable vehicle roof apparatus comprises a roof, a rear windshield hinged to the roof, a trunk cover, a rear shelf disposed at the rear windshield and moveable between a horizontal position in which the rear shelf provides a sealing structure for the vehicle and a vertical position in which the rear shelf provides a space for the passage of the roof and the rear windshield, and closure flaps mounted on the trunk cover and moveable between an extended position in which the closure flaps are located at both sides of the trunk cover respectively and a retracted position in which the closure flaps are attached to a lower surface of the trunk cover.

According to another embodiment of the invention, the present invention also provides a vehicle which comprises a retractable vehicle roof apparatus according to the above embodiment of the present invention.

In the retractable vehicle roof apparatus according to the present invention, the rear shelf is disposed at the rear windshield and moveable between a horizontal position in which the rear shelf provides a sealing structure for the vehicle and a vertical position in which the rear shelf provides a space for accommodating the roof and the rear windshield. The closure flaps are mounted on the trunk cover and moveable between an extended position in which the closure flaps are located at both sides of the trunk cover respectively and a retracted position in which the closure flaps are attached to a lower surface of the trunk cover. The rear shelf and the closure flaps are mounted separately so that the apparatus is simpler in structure and more reliable and stable in operation.

### BRIEF DESCRIPTION OF THE DRAWINGS

The aforementioned features and advantages of the invention as well as additional features and advantages thereof will be more clearly understood hereinafter as a result of a detailed description of embodiments when taken in conjunction with the drawings.

FIG. 1 is a perspective view illustrating an embodiment of the retractable vehicle roof apparatus.

FIG. 2 is a perspective view illustrating an embodiment of the rear shelf.

FIG. 3 is a perspective view illustrating an embodiment of the closure flaps.

FIG. 4 is a perspective view illustrating an embodiment of the closure flap actuating device.

FIG. 5 is a flow chart illustrating the movement process of the retractable vehicle roof apparatus when moving from the extended position to the retracted position.

FIG. 6 is a flow chart illustrating the movement process of the retractable vehicle roof apparatus when moving from the retracted position to the extended position.

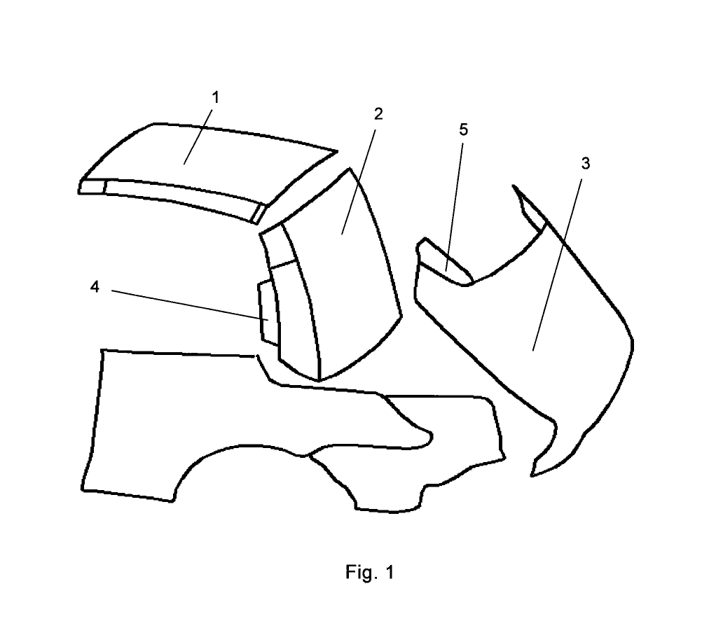

### DESCRIPTION OF THE EMBODIMENT

The present invention will be described in detail hereinafter.

Firstly, the terms used in the description are explained as follows:

The retractable hard roof apparatus: a mechanism which is moveable between a retracted position (open position) and an extended position (closed position) so as to open and close the top of the vehicle and mainly comprises a roof 1 and a rear windshield 2.

The roof 1: the roof is located at the top of the vehicle and used as the tip end of the retractable hard roof apparatus, and covers the top of the vehicle compartment.

The windshield 2: the windshield is located at the rear of the roof 1 and used as the root end of the retractable hard roof apparatus, and covers the rear of the vehicle compartment.

The trunk cover rearward-turning device: a mechanism which turns the trunk cover 3 rearwards by an angle around a shaft mounted on the vehicle body to provide a space for the retractable hard roof apparatus when the retractable hard roof apparatus moves between the retracted position and the extended position.

The rear shelf 4: the rear shelf is mounted near the hinge of the retractable hard roof apparatus, cooperates with the retractable hard roof apparatus to provide the space for the retractable hard roof apparatus, and also conceals a gap left between the up edge of the seatback of the rear seats and the down edge of the rear windshield when the retractable hard roof apparatus is in the extended position and conceals a gap left between the up edge of the seatback of the rear seats and the front edge of the trunk cover.

The closure flaps 5: a closure flap is mounted at the front of the trunk cover, cooperates with the retractable hard roof apparatus, is refracted into the trunk to provide a space to the rear windshield when the retractable hard roof apparatus is in the extended position and extended out to conceal the space so as to ensure the sealing of the vehicle when the retractable hard roof apparatus is in the retracted position.

In addition, the trunk cover rearward-turning device, rear shelf and closure flaps have a function of supplying space for the retractable hard roof apparatus.

As shown in drawings, a retractable vehicle roof apparatus according to an embodiment of the present invention comprises a roof 1, a rear windshield 2, a trunk cover 3, a rear shelf 4 and closure flaps 5. The roof 1 is hinged to the rear windshield 2. The rear shelf 4 is disposed at the rear windshield 2 when the roof 1 is resting on the vehicle frame and can move between the horizontal position at which the rear shelf 4 functions as a sealing structure and the vertical position at which the rear shelf 4 provides a space for the passage of the roof 1 and the rear windshield 2. The closure flaps 5 are mounted on the trunk cover 3 and can move between the extended position in which the closure flaps 5 are located on both sides of the trunk cover 3 and the retracted position in which the closure flaps 5 are attached to the lower surface of the trunk cover 3.

The actuating device for driving the roof 1 and the rear windshield 2 can be an existing actuating device, such as the actuating device disclosed in CN2880565Y and CN1750952A. Alternatively, the actuating device may comprise a hydraulic assembly and a four link mechanism actuated by the hydraulic assembly.

According to an embodiment of the present invention, the rear shelf 4 can be actuated by a separate rear shelf actuating device. The rear shelf 4 also can operate in a linkage relationship with the roof 1 and the rear windshield 2. Namely, the rear shelf 4 can be actuated by the actuating device of the roof 1 and the rear windshield 2.

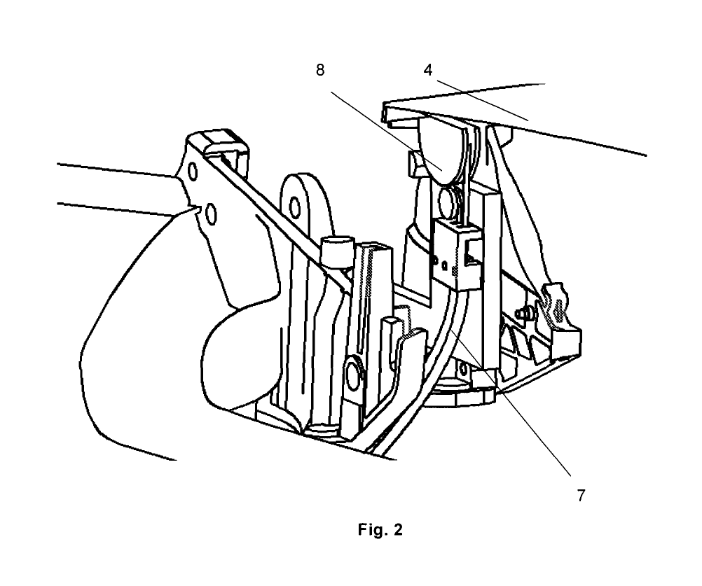

As shown in FIG. 2, the rear shelf actuating device comprises a rear shelf motor, a cable 7 which is actuated by the rear shelf motor, a pulley 8 which is actuated to rotate by the cable 7. The pulley 8 is mounted on the rear shelf 4 and actuates the rear shelf 4 to move between the horizontal position and the vertical position.

According to an embodiment of the present invention, the closure flaps 5 are actuated by a separate closure flap actuating device.

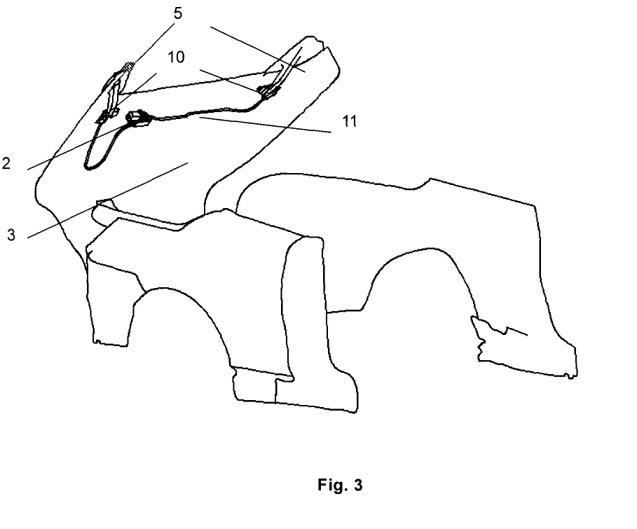

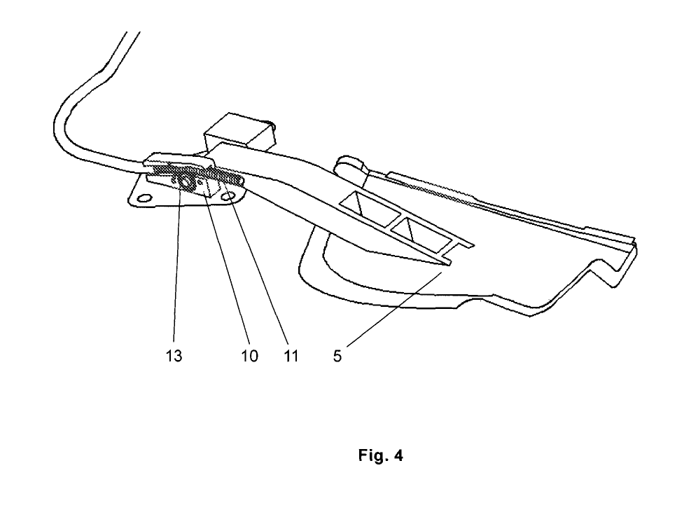

As shown in FIG. 3 and FIG. 4, the closure flap actuating device comprises a hinge 10 which is mounted on the trunk cover 3 and to which the closure flaps 5 are rotatably connected, a closure flap motor 12 which is mounted on the trunk cover 3, a flexible shaft 11 which is actuated to reciprocate by the closure flap motor 12, and a gear 13 which is mounted on the closure flap 5 and engaged with the flexible shaft 11.

Concretely, the hinge 10 is mounted on the trunk cover 3. The gear 13 is rotatably mounted on the hinge 10. The connecting arm of the closure flap 5 is fixed to the gear 13. Therefore, the closure flap 5 can rotate around the hinge 10 together with the gear 13. The flexible shaft 11 which is reciprocated by the closure flap motor 12 to move back and forth and has teeth engaged with the gear 13. The gear 13 is actuated to rotate in the hinge 10 by the flexible shaft 11 when the flexible shaft 11 reciprocates. The gear 13 which is rotated actuates the closure flap 5 to move between the extended position and the retracted position.

The closure flaps 5 and the closure flap actuating devices are mounted on both sides of the trunk cover 3 respectively. The closure flap actuating devices can use a common motor or can each use a separate motor.

In an embodiment of the present invention, movement of the roof 1, the rear windshield 2, the trunk cover 3, the rear shelf 4, and the closure flaps 5 are respectively controlled by their own sensors and electric controlling devices which are known in the art.

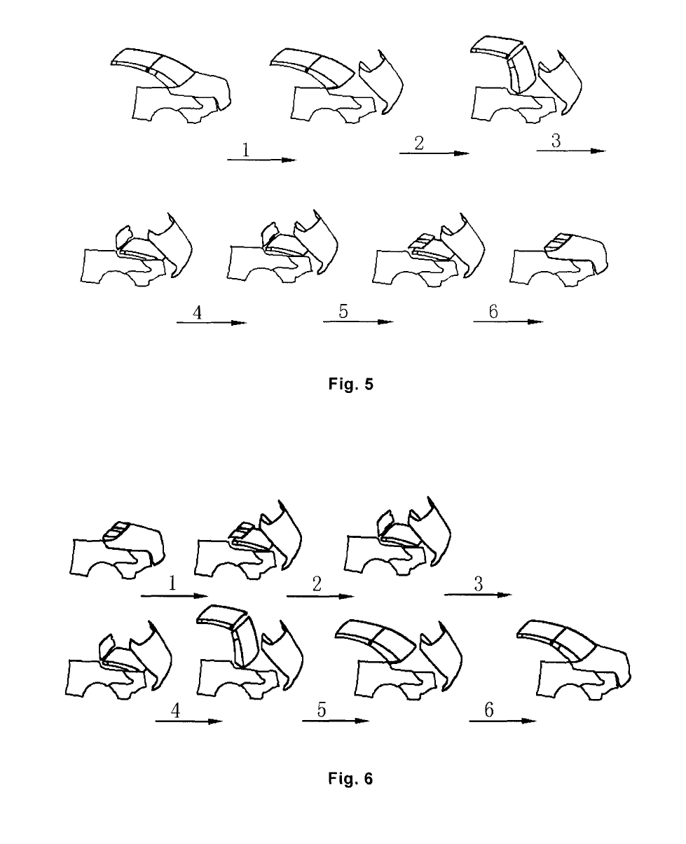

The operation of the retractable vehicle roof apparatus from extended position (closed position) to the retracted position (open position) will be described in detail referring to FIG. 5.

Step 1: the trunk cover 3 is turned over rearwards and triggers the sensor when arriving at the designated position. Then the operation of the retractable vehicle roof apparatus goes into the next step under the control of the ECU (Electric Control Unit).

Step 2: the closure flaps 5 are extended out and trigger the sensor when they reach the designated position. Then the operation of the retractable vehicle roof apparatus goes into the next step under the control of ECU.

Step 3: the retractable hard roof apparatus moves from the extended position towards the retracted position and triggers the sensor when it reaches the designated position. Then the rear shelf 4 is turned rearwards and triggers the sensor when it reaches the designated position. Then the operation of the retractable vehicle roof apparatus goes into the next step under the control of ECU.

Step 4: the retractable hard roof apparatus continues to move until it is retracted into the trunk and triggers the sensor when it reaches the designated position. Then the operation of the retractable vehicle roof apparatus goes into the next step under the control of ECU.

Step 5: the rear shelf 4 is turned to return to its position and triggers the sensor when it reaches the designated position. Then the operation of the retractable vehicle roof apparatus goes into the next step under the control of ECU.

Step 6: the trunk cover is retracted and triggers the sensor when it reaches the designated position. Then the operation of the device is ended under the control of ECU.

The sensors can be the existing sensors which are appropriate, such as proximity sensors and hall sensors. ECU can be the existing ECU.

The operation of the retractable vehicle roof apparatus from retracted position to the extended position will be described in detail referring to FIG. 6.

Step 1: the trunk cover 3 is turned rearwards and triggers the sensor when it reaches the designated position. Then the operation of the retractable vehicle roof apparatus goes into the next step under the control of ECU.

Step 2: the rear shelf is turned upwards and triggers the sensor when it reaches the designated position. Then the operation of the retractable vehicle roof apparatus goes into the next step under the control of ECU.

Step 3: the retractable hard roof apparatus moves from the retracted position towards the extended position and triggers the sensor when it reaches the designated position. Then the operation of the retractable vehicle roof apparatus goes into the next step under the control of ECU.

Step 4: the retractable hard roof apparatus continues to move until it is completely extended and triggers the sensor when it reaches the designated position. Then the operation of the retractable vehicle roof apparatus goes into the next step under the control of ECU.

Step 5: the closure flaps are retracted and trigger the sensor when it reach the designated position. Then the operation of the retractable vehicle roof apparatus goes into the next step under the control of ECU.

Step 6: the trunk cover is closed and triggers the sensor when it reaches the designated position. Then the operation of the retractable vehicle roof apparatus is ended under the control of ECU.

Although explanatory embodiments have been shown and described, it would be appreciated by those skilled in the art that changes, alternatives, and modifications can be made in the embodiments without departing from spirit and principles of the invention. Such changes, alternatives, and modifications all fall into the scope of the claims and their equivalents.

What is claimed is:

1. A retractable vehicle roof apparatus, comprising:
a roof,
a rear windshield hinged to the roof,
a trunk cover,
a rear shelf disposed at the rear windshield and moveable between a horizontal position in which the rear shelf provides a sealing structure for the vehicle and a vertical position in which the rear shelf allows the passage of the roof and the rear windshield, and
closure flaps mounted on the trunk cover and moveable between an extended position in which the closure flaps are located at both sides of the trunk cover respectively and a retracted position in which the closure flaps are retracted to a lower surface of the trunk cover.

2. The retractable vehicle roof apparatus according to claim 1, wherein the rear shelf is actuated by a separate rear shelf actuating device.

3. The retractable vehicle roof apparatus according to claim 2, wherein the rear shelf actuating device comprises a rear shelf motor, a cable actuated by the motor, and a pulley actuated to rotate by the cable and mounted on the rear shelf so as to actuate the rear shelf.

4. The retractable vehicle roof apparatus according to claim 1, wherein the movement of the rear shelf is in a linkage relationship with those of the roof and the rear windshield.

5. The retractable vehicle roof apparatus according to claim 1, wherein the closure flaps are actuated by a separate closure flap actuating device.

6. The retractable vehicle roof apparatus according to claim 5, wherein the closure flap actuating device comprises a hinge mounted on the trunk cover and hinged to one of the closure flaps, a closure flap motor mounted on the trunk cover, a flexible shaft driven to reciprocate by the closure flap motor, and a gear mounted on the one of the closure flaps and engaged with the flexible shaft.

7. The retractable vehicle roof apparatus according to claim 6, wherein one closure flap and one closure flap actuating device are provided on each side of the trunk cover, and the two closure flap actuating devices on the two sides of the trunk cover share one closure flap motor.

8. The retractable vehicle roof apparatus according to claim 1, wherein movements of the roof, the rear windshield, the trunk cover, the rear shelf, and the closure flaps are controlled by their own sensors and electric controlling devices, respectively.

9. A vehicle comprising a retractable vehicle roof apparatus according to claim 8.

10. A vehicle comprising a retractable vehicle roof apparatus according to claim 7.

11. A vehicle comprising a retractable vehicle roof apparatus according to claim 6.

12. A vehicle comprising a retractable vehicle roof apparatus according to claim 5.

13. A vehicle comprising a retractable vehicle roof apparatus according to claim 4.

14. A vehicle comprising a retractable vehicle roof apparatus according to claim 3.

15. A vehicle comprising a retractable vehicle roof apparatus according to claim 2.

16. A vehicle comprising a retractable vehicle roof apparatus according to claim 1.
